(19) United States
(12) Patent Application Publication
(10) Pub. No.: US 2025/0381990 A1
(43) Pub. Date: Dec. 18, 2025

(54) METHOD FOR PREDICTING AN INFLUENCE OF ONE ROAD USER ON AT LEAST ONE OTHER ROAD USER, AND METHOD FOR OPERATING A VEHICLE

(71) Applicant: MERCEDES-BENZ GROUP AG, Stuttgart (DE)

(72) Inventor: Thomas MONNINGER, Sunnyvale, CA (US)

(21) Appl. No.: 18/880,886

(22) PCT Filed: Jun. 21, 2023
(86) PCT No.: PCT/EP2023/066809

§ 371 Date: Jan. 3, 2025

(30) Foreign Application Priority Data
Jul. 5, 2022 (DE) 10 2022 002 457.8

(51) Int. Cl. B60W 60/00; B60W 30/095; B60W 40/04; G01C 21/36; G08G 1/16

(52) U.S. Cl. CPC B60W 60/00276; B60W 30/0956; B60W 40/04; B60W 60/0011; G01C 21/3691; G08G 1/16; B60W 2554/20; B60W 2554/4046; B60W 2556/40

(57) ABSTRACT

An influence of one road user on at least one other road user is predicted by evaluating traffic scenarios by a trained artificial neural network. The neural network is trained by recorded traffic scenarios, the traffic scenarios include several road users and are labelled with score values that represent an influence of one road user by other road users. A respective score value for one road user with respect to another road user is calculated based on a deviation between two trajectories of the one road user. One of the two trajectories is a detected real trajectory that the one road user actually takes in a respective recorded traffic scenario, and the other of the two trajectories is a simulated trajectory determined in a simulation and representing a trajectory that the one road user would take in the same traffic scenario if the other road user were not present.

### BACKGROUND AND SUMMARY OF THE INVENTION

Exemplary embodiments of the invention relate to a method for predicting an influence of one road user on at least one other road user, as well as to a method for operating a vehicle.

DE 10 2021 005 625.6 describes a method for predicting the trajectory of vehicles within the surroundings of an ego vehicle by means of a trained artificial neural network. In this method, degrees of interaction between the vehicles are determined by a machine-trained attention-based interaction algorithm. By means of the interaction algorithm, individual vehicles from the set of vehicles within the surroundings of the ego vehicle are identified as relevant for the trajectory prediction and selected for this if their respective degree of interaction with at least one of the vehicles, the trajectory of which is to be predicted, exceeds a specified limit value. In a subsequent learning step, a trajectory prediction algorithm is trained using exclusively the vehicles selected as relevant for the trajectory prediction and the trajectory prediction made by the trajectory prediction algorithm is carried out exclusively for the vehicles selected as relevant for the trajectory prediction. Furthermore, a method for the automated operation of an ego vehicle is described, wherein trajectories of vehicles within the surroundings of an ego vehicle are predicted and the predicted trajectories are taken into account in the automated operation of the ego vehicle during automated lateral and/or longitudinal control of the ego vehicle.

Exemplary embodiments of the invention are directed to a novel method for predicting an influence of one road user on at least one other road user and a novel method for operating a vehicle.

In the method for predicting an influence of one road user on at least one other road user by evaluating traffic scenarios by means of a trained artificial neural network, according to the invention the neural network is trained by means of recorded traffic scenarios. These traffic scenarios include several road users and are labelled with score values representing an influence of one road user by other road users. A respective score value for one road user with respect to another road user is calculated based on a determination of a deviation between two trajectories of the one road user. In this case, one of the two trajectories is a detected real trajectory that the one road user actually takes in a respective recorded traffic scenario. The other of the two trajectories is a simulated trajectory determined in a simulation and represents a trajectory that the one road user would take in the same traffic scenario if the other road user were not present.

For an automated-driving ego vehicle according to levels 2 to 5 of the standard SAE J3016, as well as active collision avoidance systems according to NCAP, it is necessary to precisely detect road users within the surroundings of the ego vehicle. To plan a safe and collision-free trajectory for the ego vehicle, future trajectories of circumjacent road users also have to be correctly predicted. This requires is an inherent understanding of the influence of each road user on other road users in order to take account of interaction dependencies.

To quantify these interactions, the present method provides a scalar influence metric in the form of the score value and a method for learning this influence metric.

In a particularly advantageous manner, the method enables an explicit formulation of an influence score at the level of the interaction between at least two road users. In this way it is possible to extract the score value from any traffic scenario, so that it can be used as a label and/or ground truth. In particular, the method enables a learning-based approach, which uses the generated score values as a label and, based on a constellation of circumjacent road users and optionally an underlying infrastructure, such as for example traffic lanes, traffic rules etc., learns how to predict this score value in live operation.

In one possible embodiment the method, the deviation between the two trajectories is determined by means of an average displacement error and/or a final displacement error. The minimum average displacement error indicates how far each calculated position of the respective trajectory is on average from its true position. The minimum final displacement error indicates a deviation of a prediction from a true trajectory for the respective last prediction step.

In a further possible embodiment of the method, an influence of one road user on exactly one other road user is determined from the score value of the road user. This means that the score value is considered to be a relative quantity in order to describe a relative effect of one road user on a further, specific road user.

In a further possible embodiment of the method, an influence of one road user on all other road users in a respective traffic scene is determined from the score value of the road user. That means that the score value is considered to be an absolute quantity and is used to describe a global effect of one road user on the traffic scenario.

In a further possible embodiment of the method, the trained artificial neural network employs a map-free approach that uses dynamic information about the other road users as input information. As an alternative or in addition, the trained artificial neural network employs a scene graph that uses all available information, including information about a static infrastructure from a map. Both options, in each case alone and also together, lead to efficient and successful training.

In the method for operating a vehicle, according to the invention, the influence of one road user on at least one other road that is predicted in the aforementioned method or an embodiment thereof is used to perform a vehicle function. This results in particularly reliable operation of the vehicle function.

In one possible embodiment of the method for operating the vehicle, a probability of a collision occurring between an ego vehicle and a circumjacent road user is determined using the predicted influence of the circumjacent road user with respect to the ego vehicle by means of a collision warning and/or collision avoidance system of the ego vehicle. This determination is particularly efficient and reliable because of the use of the predicted influence.

In a further possible embodiment of the method for operating the vehicle, the predicted influence is used as a heuristic to restrict a search area to at least one relevant road user when an automated vehicle is pathfinding. This enables a particularly efficient operation of the corresponding vehicle function.

In a further possible embodiment of the method for operating the vehicle, the predicted influence is used as input parameter of a trajectory prediction approach and a level of interaction between pairs of road users is modelled. This enables trajectories to be predicted particularly accurately.

### BRIEF DESCRIPTION OF THE DRAWING FIGURES

Exemplary embodiments of the invention are in explained in more detail in the following with reference to drawings, in which:

FIG. 1 schematically shows a plan view of a traffic situation,

FIG. 2 schematically shows a plan view of a further traffic situation,

FIG. 3 schematically shows a plan view of a further traffic situation,

FIG. 4 schematically shows trajectories of a vehicle from the traffic situations according to FIGS. 2 and 3, and

FIG. 5 schematically shows a structure of a graph as well as processing of the information present in the graph structure using a graph-based artificial neural network.

Mutually corresponding parts are given the same reference numerals in all the figures.

### DETAILED DESCRIPTION

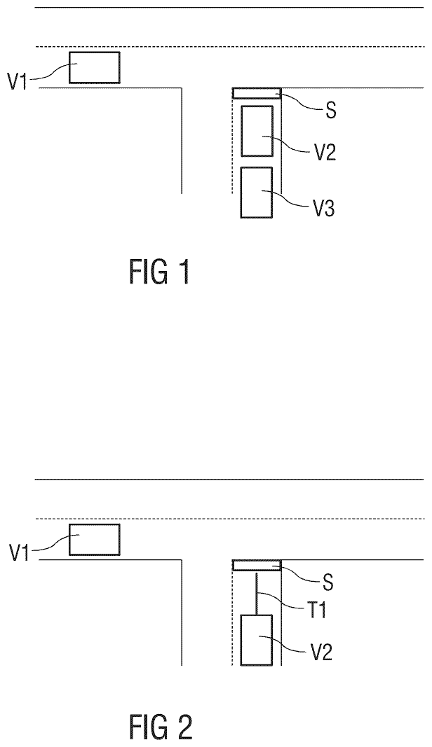

FIG. 1 shows a plan view of a traffic situation at a T junction. In this case, the road user V1, in the form of a vehicle, is on a priority road and two other road users V2, V3, also in the form of vehicles, are stationary one behind the other at a stop line S. In this case, an influence of the road user V1 on the road user V2 is large, since the road user V1 is the reason the road user V2 has stopped. An influence of the road user V2 on the road user V3 is also large, since the road user V3 would otherwise have driven right up to stop line S.

To quantify interactions between the road users V1 to V3, an influence metric, also referred to as a score value, and a method for learning this influence metric are made available in the present case

To determine the influence of one road user V1 to V3 on another road user V1 to V3, a deviation of a trajectory T1, T2 is determined, which the one road user V1 to V3 would take if the other road user V1 to V3 under consideration were not present.

As FIG. 2 shows, the road user V2 stops at the stop line S when driving along the trajectory T1 because of the approaching road user V1.

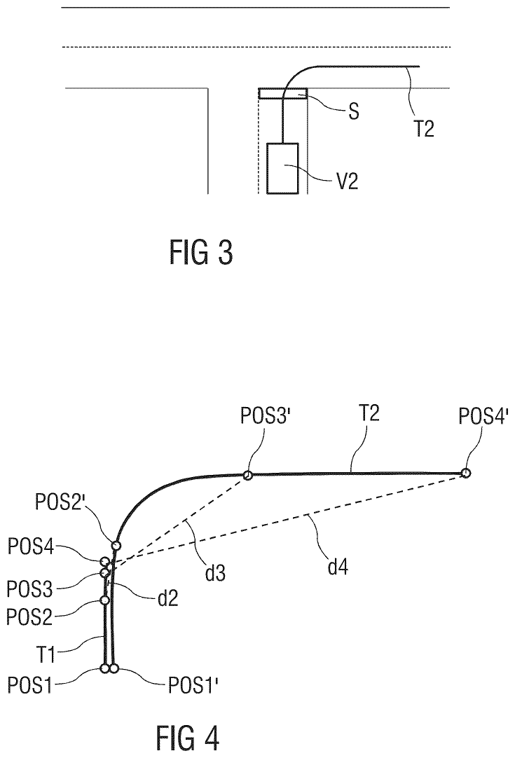

To quantify the influence of the road user V1 on the road user V2 by means of this influence metric, FIG. 3 shows the same situation without the road user V1. Here the road user V2 does not stop at the stop line S, but rather follows the trajectory T2 and turns right.

The deviation between the two trajectories T1, T2 is accordingly large, as is the influence of the road user V1 on the road user V2 according to the influence metric. This is plausible since the road user V2 actually interacts with the road user V1 and only drives once the road user V1 has passed the junction.

The influence metric eij for determining the influence of a road user i on a road user j is calculated using a distance measure D on a trajectory t of j given i and on a trajectory t of j not given i according to

$${e}_{i , j} = D ( {t}_{j \vert i} , {t}_{j \vert ¬ i} ) \qquad ( 1 )$$

All influence metrics that can compare two time series can be used as distance measures, for example the so-called average displacement error (ADE) or the so-called final displacement error (FDE) according to

$${D}_{ADE} = \frac{1}{T} {\sum }_{i = 1}^{T} \sqrt{{( {x}_{i}^{1} - {x}_{i}^{2} )}^{2} + {( {y}_{i}^{1} - {y}_{i}^{2} )}^{2}} and \qquad ( 2 )$$

$${D}_{FDE} = \sqrt{{( {x}_{T}^{1} - {x}_{T}^{2} )}^{2} + {( {y}_{T}^{1} - {y}_{T}^{2} )}^{2}} \qquad ( 3 )$$

In addition, the influence can be calculated absolutely or relatively. Relative describes the influence of the road user i on the road user j, absolute describes the influence of road user i on all circumjacent road users:

$${e}_{i} = {\sum }_{j = 1}^{N} {e}_{i , j} \qquad ( 4 )$$

If the influence metric in the form of an average displacement error is applied to the traffic scenario shown in FIGS. 2 and 3, a situation as shown in FIG. 4 arises with the trajectories T1, T2 and positions POS1 to POS4, POS1′ to POS4′ of the trajectories T1, T2 per second.

Deviations d2 to d4 are formed between the individual positions POS1 to POS4, POS1′ to POS4′ of the trajectories T1, T2, which still have the value zero at the position POS1, POS1′, and grow with each further position POS2 to POS4, POS2′ to POS4′. The reason for this is that the road user V2 stops at the stop line S when driving along the trajectory T1 and turns right when driving along the trajectory T2.

To calculate the influence, two trajectories T1, T2 of the road user V2 are therefore required. One trajectory T1 for the case that the road user V1 exists, and the other trajectory T2 for the case that the road user V1 does not exist.

Recorded data contains only the case in which the road user V1 exists. The other case would require a so-called intervention, i.e., an intervention in the surroundings, which is not possible retrospectively. In this regard, see for example “Judea Pearl: Causality: Models, Reasoning, and Inference”.

In order nevertheless to obtain a trajectory T2 for this case, the traffic scenario is re-simulated, and the surrounding area is adopted apart from the road user V1. A module for the trajectory planning can now run through the same traffic scenario once more, with the sole difference that the road user V1 is missing. In this way, an intervention is realized in the simulation.

For recorded traffic scenarios, this method can be used to quantify the influence of each road user V1 to V3 on in each case each other road user V1 to V3 in the scenario. This score value is now used as a label in a learning-based method, the aim of which is to predict the influence.

Any inputs can be used in the process. For example, a so-called map free approach can be used, which merely uses dynamic information DI about the circumjacent road users V1 to V3 as input information.

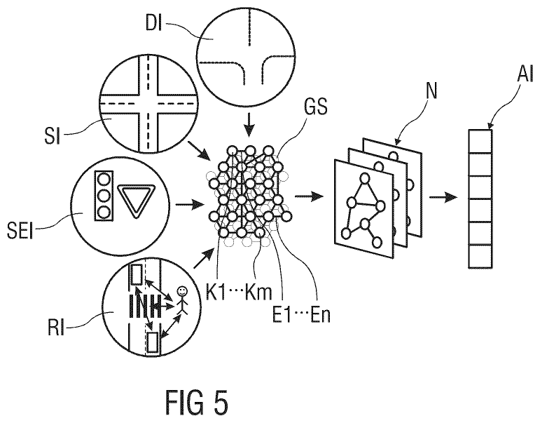

However, a scene graph can also be used, which uses all available information, including information about a static infrastructure from a map. This is shown in FIG. 5 using a graph structure GS and the processing in the graph structure GS of present information with a graph-based artificial neural network N. This graph structure GS comprises several nodes K1 to Km, which are connected by edges E1 to En.

Static information SI, the dynamic information DI, semantic information SEI and relational information RI are transferred to the graph structure GS as input information for the traffic scenario.

Subsequently, a form of a learning-based method is used, in particular the graph-based artificial neural network N, wherein output information AI provides information about the influence of one road user V1 to V3 on at least one further road user V1 to V3.

The learning-based method thus makes it possible to predict the influence of one road user V1 to V3 on another road user V1 to V3. This information can be used in a collision warning system, for a trajectory prediction approach or for a trajectory planning approach.

Although the invention has been illustrated and described in detail by way of preferred embodiments, the invention is not limited by the examples disclosed, and other variations can be derived from these by the person skilled in the art without leaving the scope of the invention. It is therefore clear that there is a plurality of possible variations. It is also clear that embodiments stated by way of example are only really examples that are not to be seen as limiting the scope, application possibilities or configuration of the invention in any way. In fact, the preceding description and the description of the figures enable the person skilled in the art to implement the exemplary embodiments in concrete manner, wherein, with the knowledge of the disclosed inventive concept, the person skilled in the art is able to undertake various changes, for example, with regard to the functioning or arrangement of individual elements stated in an exemplary embodiment without leaving the scope of the invention, which is defined by the claims and their legal equivalents, such as further explanations in the description.

1-9. (canceled)

10. A method comprising:
predicting an influence of one road user on at least one other road user by evaluating traffic scenarios using a trained artificial neural network,
wherein the artificial neural network is trained using recorded traffic scenarios, wherein the recorded traffic scenarios include several road users and the recorded traffic scenarios are labelled with score values representing an influence of one road user of the several road users by other road users of the several road users,
a respective score value for one road user of the several road users with respect to another road user of the several road users is calculated based on a determination of a deviation between two trajectories of the one road user of the several road users,
wherein one of the two trajectories is a detected real trajectory that the one road user of the several road users actually takes in a respective recorded traffic scenario, and
wherein a second of the two trajectories is a simulated trajectory determined in a simulation and representing a trajectory that the one road user would take in a same traffic scenario if the another road user of the several road users were not present.

11. The method of claim 10, wherein the deviation between the two trajectories is determined by an average displacement error or a final displacement error.

12. The method of claim 10, wherein an influence of the one road user of the several road users on exactly one other road user of the several road users is determined from the score value of the one road user of the several road users.

13. The method of claim 10, wherein an influence of the one road user of the several road users on all other road users of the several road users in a respective traffic scene is determined from the score value of the one road user of the several road users.

14. The method of claim 10, wherein the trained artificial neural network employs
a map-free approach that uses dynamic information about the other road users of the several road users as input information, or
a scene graph that uses all available information, including information about a static infrastructure from a map.

15. A method for operating a vehicle, the method comprising:
predicting an influence of one road user on at least one other road user by evaluating traffic scenarios using a trained artificial neural network; and
using the predicted influence to perform a function of the vehicle,
wherein the artificial neural network is trained using recorded traffic scenarios, wherein the recorded traffic scenarios include several road users and the recorded traffic scenarios are labelled with score values representing an influence of one road user of the several road users by other road users of the several road users,
a respective score value for one road user of the several road users with respect to another road user of the several road users is calculated based on a determination of a deviation between two trajectories of the one road user of the several road users,
wherein one of the two trajectories is a detected real trajectory that the one road user of the several road users actually takes in a respective recorded traffic scenario, and
wherein a second of the two trajectories is a simulated trajectory determined in a simulation and representing a trajectory that the one road user would take in a same traffic scenario if the another road user of the several road users were not present.

16. The method of claim 15, wherein a probability of a collision occurring between an ego vehicle and a circumjacent road user is determined using the predicted influence of the circumjacent road user with respect to the ego vehicle by a collision warning or collision avoidance system of the ego vehicle.

17. The method of claim 15, wherein the predicted influence is used as a heuristic to restrict a search area to at least one relevant road user when an automated vehicle is pathfinding.

18. The method of claim 15, wherein the predicted influence is used as input parameter of a trajectory prediction approach and a level of interaction between pairs of road users is modelled.
